(19) United States
(12) Patent Application Publication
(10) Pub. No.: US 2008/0252213 A1
(43) Pub. Date: Oct. 16, 2008

(54) Plasma display panel and method of fabrication thereof

(76) Inventor: Yasushi Sano, Ohnomachi Ichikawa city (JP)

Correspondence Address: Yasushi Sano, 2-854-1-110, Ohnomachi, Ichikawa city, Chiba, 272-0805, JP

(21) Appl. No.: 10/726,304

(22) Filed: Dec. 1, 2003

(30) Foreign Application Priority Data
Sep. 17, 2003 (JP) P2003-363865

(51) Int. Cl. H01J 17/49; H01J 9/02

(52) U.S. Cl. 313/584; 445/24

(57) ABSTRACT

A low-cost process technology is proposed for the making and manufacture of bus electrodes or fence electrodes, which are structural parts or objects of a Plasma Display Panel (PDP). The low-cost process proposed makes the above-mentioned bus electrodes or fence electrodes that exhibit outstanding conductivity and sufficient shading characteristics. The proposed PDP has a front panel and a back panel. The back panel is set at a fixed distance from the front panel. The front panel has a number of two or more sustain scan electrodes arranged in parallel on the above-mentioned front panel surface, two or more data electrodes arranged in the direction which crosses the above-mentioned sustain scan electrodes, and two or more partitions that are arranged between the above-mentioned front panel and the above-mentioned back panel, in order to divide the electric discharge cell. The above-mentioned sustain scan electrode has a transparent electrode and a bus electrode arranged on the above-mentioned transparent electrode. The above-mentioned bus electrode is formed sequentially from the side that touches the above-mentioned transparent electrode with a double-layer composition. The double layer composition is composed of a black ground layer and a non-black electric conduction layer. The above-mentioned bus electrode is formed by first exposing light or lights on a positive type photosensitive paste on the above-mentioned black ground layer by using the above-mentioned non-black electric conduction layer as a pattern formation mask, and secondly the above-mentioned black ground layer is applied.

### FIELD OF THE INVENTION

The present invention relates to a plasma display panel (PDP) and a method for fabricating thereof and particularly those panels having a high contrast scan sustain electrode.

### DESCRIPTION OF THE BACKGROUND ART

In general, a PDP of the type described has various advantages such as a thin structure, a high contrast ratio, a high-speed response can be achieved, and a large size screen can be realized without flickering. Therefore, it is a recent trend that PDPs have been widely used in various fields related to computers, TVs and the like.

PDPs consist of a front panel, which is a view front side panel, and a back panel. FIG. 6 shows the structure of the front panel in the middle of the manufacturing process. The front panel has a sustain scan electrode 1 which is a transparent electrode on an inner surface of a front glass panel 100. A bus electrode 2, which has high electric conductivity, is arranged on the transparent sustain scan electrode. At the final step of the PDP front panel fabricating process, the front panel has an upper transparent dielectric layer on the sustain and scan electrodes and the bus electrodes shown in FIG. 6, and a protection layer of MgO covers the upper transparent dielectric layer to prevent damage of the dielectric layer by impact of the ions generated by plasma discharge. One of the pairs of the sustain scan electrodes with bus electrodes generates an opposite discharge together with an address electrode on a back panel (not drawn in FIG. 6) in response to scan pulses supplied in the address period. Visible rays corresponding to R, G, and B colors are shown through the transparent sustain scan electrodes. Conventionally, the above-mentioned bus electrode is formed by evaporating or sputtering Cr—Cu—Cr triple metal layers, and subsequent patterning of the metal layers. However, this process is a high cost process. Some bus electrode formation processes are proposed to save costs and have been adopted; silver paste is selectively printed by screen a printing method and dried. After this, photo sensitive electric conductive paste is printed on all surfaces and partially photo illuminated and then applied, and so on. Recently, a new bus electrode structure has been proposed to improve display contrast with high electric conductivity; the bus electrode 2 has a black ground layer 3 and a non-black electric conductive layer 4 on top. Generally speaking, the non-black electric conductive layer is a silver paste and the black layer is an oxidized compound of a Cu—Fe system or a Cu—Cr system or an oxidized Co.

A Japanese Unexamined Patent Publication No. 2003-217460-A shows a process technology pertaining to the above-mentioned bus electrode, which has black and non-black double layers. This technology forms the bus electrode by putting a double layer sheet on the transparent sustain scan electrode on the front panel.

A Japanese Unexamined Patent Publication 2003-208852-A shows a process technology pertaining to the above-mentioned bus electrode, which has black and non-black double layers. This technology has features that avoid the transparent sustain scan electrode yellowing.

A Japanese Unexamined Patent Publication 2003-141450-A shows a low cost process technology pertaining to the above-mentioned black and non-black double layers.

A Japanese Unexamined Patent Publication 2003-131365-A shows a process technology pertaining to the above-mentioned black and non-black double layers by using a negative type photosensitive black ground layer paste.

A Japanese Unexamined Patent Publication 2003-249172-A shows a process technology pertaining to the above-mentioned black and non-black double layer showing the feature of using an insulator material for the black ground layer.

A Japanese Unexamined Patent Publication H11-65482-A shows a process technology comprising the following steps: Making a hollow first; burring a black material and a non-black electric conductive material second; making a transparent sustain scan electrode on the buried hollow third.

A Japanese Unexamined Patent Publication 2003-234073-A shows a process technology to make a hollow for a bus electrode.

The conventional sustain scan electrode should have a narrow-width bus electrode in order to keep a large transparent area. The above-mentioned references are a technical trial to maintain a large area. However, it is difficult to form a low cost narrow bus electrode cost by conventional fabrication methods.

A Japanese Patent No. 2003-500796-W shows a comb shape sustain scan electrode structure that does not have any transparent electrodes. The comb shape sustaining scan electrode is called a fence electrode. FIG. 7 shows a conventional fence electrode structure from a plane view, and a cross-sectional view at the A-A′ position in (a) and (b) respectively. Fence electrodes 10 arranged on a front panel 100 and fence electrodes are electrically connected to each other by tiny bridge conductive electrodes. The fence electrode has a single layer, and does not have enough black color and electrical conductivity.

### SUMMARY OF THE INVENTION

The invention is characterized firstly by comprising the following; A front panel and a back panel which are set at with a fixed distance from the front panel, a number of two or more sustain scan electrodes arranged in parallel on the above-mentioned front panel surface.

The front panel has two or more data electrodes arranged in the direction that crosses over the above-mentioned sustain scan electrodes, and two or more partitions that are arranged between the above-mentioned front panel and the above-mentioned back panel, in order to divide an electric discharge cell.

The above-mentioned sustain scan electrode has a transparent electrode and a bus electrode arranged on the above-mentioned transparent electrode.

The above-mentioned bus electrode is formed sequentially from the side, which touches the above-mentioned transparent electrode with a double layer composition made of a black ground layer and a non-black electric conduction layer.

The above-mentioned bus electrode is formed by light exposure by using the above-mentioned non-black electric conduction layer as a pattern formation mask, to which the positive type photosensitivity paste of the above-mentioned black ground layer was applied and then dried.

The invention is characterized 2ndly by the following features; the above-mentioned black ground layer is formed by, at first, being deposited on the entire surface, and secondly, being dried and, thirdly, being partially stiffened at the part which is touched by the above-mentioned selectively deposited non-black electric conduction layer by chemical reaction, fourthly, being partially removed at the non-stiffened black ground layer.

The invention is characterized 3rdly by the following features; the above-mentioned black ground layer is formed by, at first, being deposited all surface, and secondly, being dried and, thirdly, being selectively deposited on the above-mentioned non-black electric conduction layer, and partially removed from the part of the above-mentioned black ground layer that is not covered by the above-mentioned non-black electric conduction layer by physical or chemical etching.

The invention is characterized 4thly by comprising of a front panel and a back panel that are set at a fixed distance from the front panel, a number of two or more of sustain scan electrodes arranged in parallel on the above-mentioned front panel surface.

The front panel has two or more data electrodes arranged in the direction that crosses over the above-mentioned sustain scan electrodes, and two or more partitions that are arranged between the above-mentioned front panel and the above-mentioned back panel in order to divide an electric discharge cell.

The above-mentioned sustain scan electrode is formed sequentially from the side which touches the above-mentioned front panel with a double layer composition of a black ground layer and a non-black electric conduction layer.

The above-mentioned sustain scan electrode is formed by carrying out light exposure by using the above-mentioned non-black electric conduction layer as a pattern formation mask on which the positive type photosensitivity paste of the above-mentioned black ground layer was applied and then dried.

The invention is characterized 5thly by the following features; the above-mentioned black ground layer is formed firstly by being deposited on the entire surface, and secondly, being dried and, thirdly, being partially stiffened at the part that is touched by the above-mentioned selectively deposited non-black electric conduction layer with a chemical reaction, and fourthly, being partially removed from the non-stiffened black ground layer.

The invention is characterized 6thly by the following features; the above-mentioned black ground layer is formed firstly by being deposited on the entire surface, and secondly, being dried and, thirdly, being selectively deposited the above-mentioned non-black electric conduction layer, and the part of the above-mentioned black ground layer which is not covered by the above-mentioned non-black electric conduction layer partially removed by physical or chemical etching.

The invention is characterized 7thly by the following fabrication process features comprising the following steps: A transparent electrode is deposited and patterned on a front panel; a black color positive type photosensitivity paste is deposited on both surfaces of the transparent electrode and the area of the front panel that is not covered by the transparent electrode; the black color positive type photosensitivity paste is dried; a non-black electric conduction layer is selectively deposited by a screen printing method on the deposited black color positive type photosensitivity paste; the part of the black color positive type photosensitivity paste that is not covered by the non-black electric conduction layer is exposed to light; the exposed black color positive type photosensitivity paste is removed by an application process; the front panel is dried.

The invention is characterized 8thly by the following fabrication process features comprising the following steps: A transparent electrode is deposited and patterned on the front panel; a black color positive type photosensitivity paste is selectively deposited on the transparent electrode; the black color positive type photosensitivity paste is dried; a non-black electric conduction layer is selectively deposited by a screen printing method on the deposited black color positive type photosensitivity paste; the part of the black color positive type photosensitivity paste that is not covered by the non-black electric conduction layer is exposed to light; the exposed black color positive type photosensitivity paste is removed by an application process; the front panel is dried.

The invention is characterized 9thly by the following fabrication process features comprising the following steps: A transparent electrode is deposited and patterned on the front panel; a black color paste is deposited on both surfaces of the transparent electrode and the area of the front panel that is not covered by the transparent electrode; the black color paste is dried; a non-black electric conduction layer is selectively deposited on the deposited black color paste by a screen printing method; the black color paste is partially stiffened with a chemical reaction at the place where it is touched by the selectively deposited above-mentioned non-black electric conduction layer; a part of non-stiffened black ground layer is removed.

The invention is characterized 10thly by the following process features comprising the following steps: A transparent electrode is deposited and patterned on the front panel; a black color paste is selectively deposited on the transparent electrode; the black color paste is dried; a non-black electric conduction layer is selectively deposited by a screen printing method on the deposited black color paste; the black color paste is partially stiffened with a chemical reaction at the place where it is touched by the selectively deposited above-mentioned non-black electric conduction layer; a part of non-stiffened black ground layer is removed.

The invention is characterized 11thly by the following process features comprising the following steps: A transparent electrode is deposited and patterned on the front panel; a black color paste is deposited on both surfaces of the transparent electrode and the area of the front panel that is not covered by the transparent electrode; the black color paste is dried; a non-black electric conduction layer is selectively deposited by a screen printing method on the deposited black color paste; the part of the deposited black color paste that is not covered by the above-mentioned non-black electric conduction layer is removed by physical or chemical etching.

The invention is characterized 12thly by the following process features comprising the following steps: A transparent electrode is deposited and patterned on the front panel; a black color paste is selectively deposited on the transparent electrode; the black color paste is dried; a non-black electric conduction layer is selectively deposited by a screen printing method on the deposited black color paste; the part of the deposited black color paste that is not covered by the above-mentioned non-black electric conduction layer is removed by physical or chemical etching.

The invention is characterized 13thly by the following process features comprising the following steps: A black color positive type photosensitivity paste is deposited on the entire surface of the front panel; the black color positive type photosensitivity paste is dried; a non-black electric conduction layer is selectively deposited by a screen printing method on the deposited black color positive type photosensitive paste; the part of the black color positive type photosensitive paste that is not covered by the non-black electric conduction layer is exposed to light; the exposed black color positive type photosensitive paste is removed by an application process; the front panel is dried.

The invention is characterized 14thly by the following process features comprising the following steps: A black color positive type photosensitive paste is selectively deposited on the front panel; the black color positive type photosensitive paste is dried; a non-black electric conduction layer is selectively deposited by a screen printing method on the deposited black color positive type photosensitive paste; the part of the black color positive type photosensitive paste that is not covered by the non-black electric conduction layer is exposed to light; the exposed black color positive type photosensitive paste is removed by an application process; the front panel is dried.

The invention is characterized 15thly by the following process features comprising the following steps: A black color paste is deposited on the entire surface of the front panel; the black color paste is dried; a non-black electric conduction layer is selectively deposited by a screen printing method on the deposited black color paste; the part of the black color paste that is touched by the selectively deposited above-mentioned non-black electric conduction layer is stiffened with a chemical reaction; the non-stiffened black color paste is removed; the front panel is dried.

The invention is characterized 16thly by the following process features comprising the following steps: A black color paste is selectively deposited on the front panel; the black color paste is dried; a non-black electric conduction layer is selectively deposited by a screen printing method on the deposited black color paste; the part of the black color paste that is touched by the selectively deposited above-mentioned non-black electric conduction layer is stiffened with a chemical reaction; the non-stiffened black color paste is removed; the front panel is dried.

The invention is characterized 17thly by the following process features comprising the following steps: A black color paste is deposited on the entire surface of the front panel; the black color paste is dried; a non-black electric conduction layer is selectively deposited by a screen printing method as a stripe pattern on the deposited black color paste; the part of the black color paste that is not covered by the above-mentioned non-black electric conduction layer is removed by physical or chemical etching.

The invention is characterized 18thly by the following process features comprising the following steps: A black color paste is selectively deposited as a stripe pattern on the front panel; the black color paste is dried; a non-black electric conduction layer is selectively deposited by a screen printing method as a stripe pattern on the deposited black color paste; the part of the black color paste that is not covered by the above-mentioned non-black electric conduction layer is removed by physical or chemical etching.

### BRIEF DESCRIPTION OF THE DRAWING

FIG. 1 is the fabricating process flow drawing showing the first embodiment of this invention.

FIG. 2 is the fabricating process flow drawing showing the second embodiment of this invention.

FIG. 3 is the fabricating process flow drawing showing the third embodiment of this invention.

FIG. 4 is the sustain scan electrode composition drawing showing the fourth embodiment of this invention.

FIG. 5 is the fabricating process flow drawing showing the fourth embodiment of this invention.

FIG. 6 is a conventional front panel composition drawing.

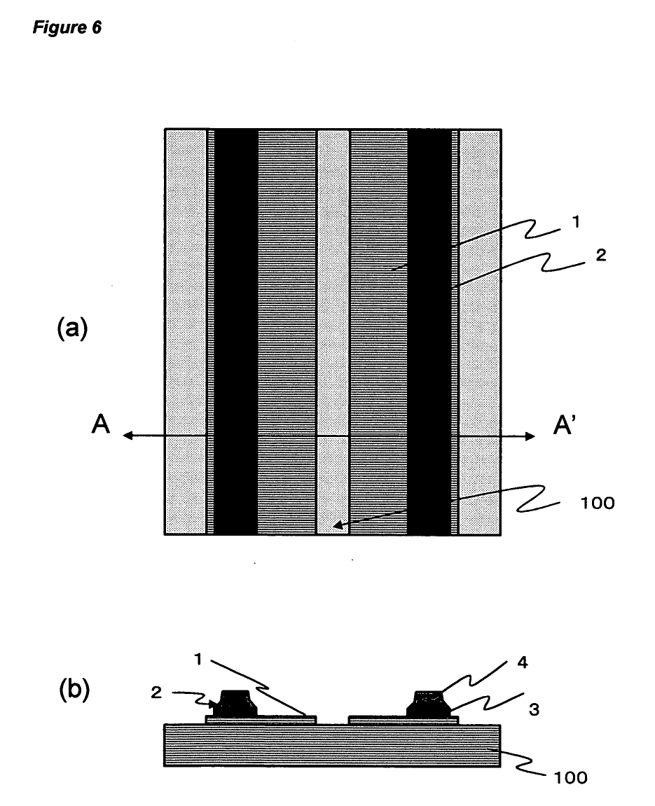

FIG. 7 is a conventional sustain scan electrode composition drawing.

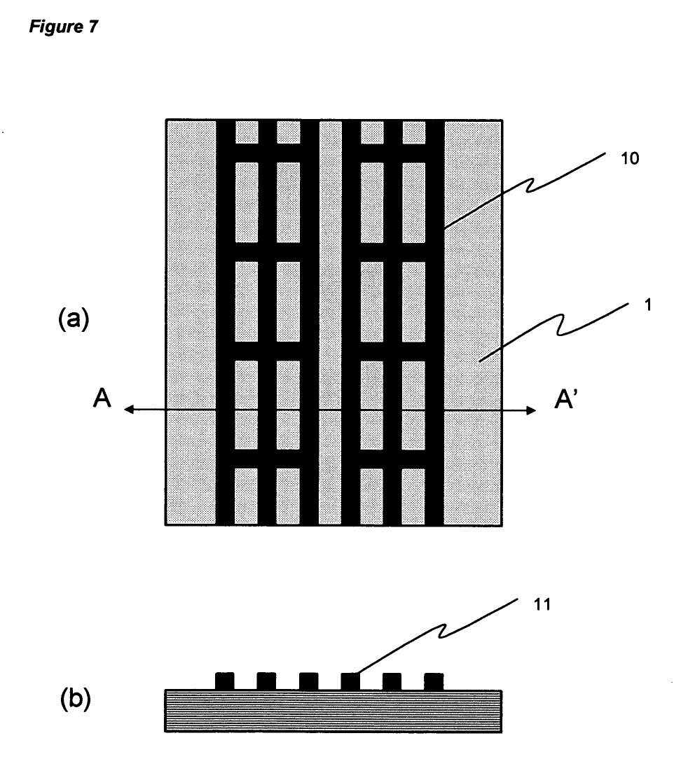

### DESCRIPTION OF THE PREFERRED EMBODIMENTS

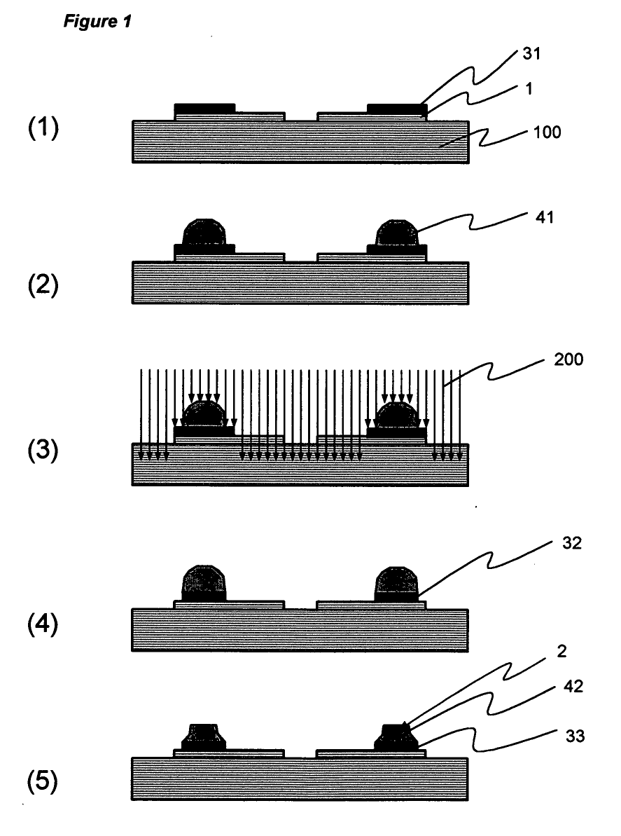

The preferred embodiment is explained by using FIG. 1. This embodiment is a front panel structure and is a method of fabricating for a 42-inch diagonal size wide-VGA color-PDP. FIG. 1 shows a part of the fabricating process flow, especially the formation steps of the bus electrode. In FIG. 1, the fabrication method for a bus electrode 2 on a sustain scan electrode 1 on a front panel 100 is shown by process steps from step 1 to step 5.

At step 1, a sustain scan electrode is firstly formed on the front panel 100, and secondly a positive type photosensitive black color paste 31 is selectively printed by a screen printing method on part of the surface of the sustain scan electrode. One pixel has two sustain scan electrodes as shown in FIG. 1. The width of the transparent sustain scan electrode is 260 μm. The gap between the two transparent sustain electrodes is 80 μm. The positive type photosensitive black color paste is printed to a width of 140 μm on the sustain scan electrode by alignment with the ground sustain scan electrode pattern. The screen mask for the positive type photosensitive black color paste printing is 1800×1800 mm frame size and a stainless steel 400 mesh screen. The black color paste has a viscosity coefficient of 30 Pa·s and the printed thickness of the paste is in the range of 3 to 4 μm after it is dried.

At step 2, a silver paste is printed on the above-mentioned positive type black color paste pattern by aligning it to the paste pattern. The silver paste has a viscosity coefficient of 150 Pa·s, and is printed with the mask that has a stainless steel 400 mesh that is 20 μm thick and has a 80 μm width open area emulsion. After it is dried, the thickness of the silver paste and the width of the contact interface between the silver paste and the ground black paste are in the range of 14 to 16 μm and 80 μm respectively. The cross sectional view of the silver paste at step 2 is a half moon shape. The half moon shape silver paste is labeled as a dried non-black conductive paste 41 in FIG. 1.

At step 3, ultraviolet rays 200 irradiate from the above-mentioned non-black electric conductive paste to the front panel. At this irradiation process step, a part of the photosensitive paste covered by the electric conductive paste is shielded from the ultraviolet rays and the other parts of the photosensitive paste are irradiated by the ultraviolet rays. The non-black conductive paste works itself as a photo-mask for the ground black color layer.

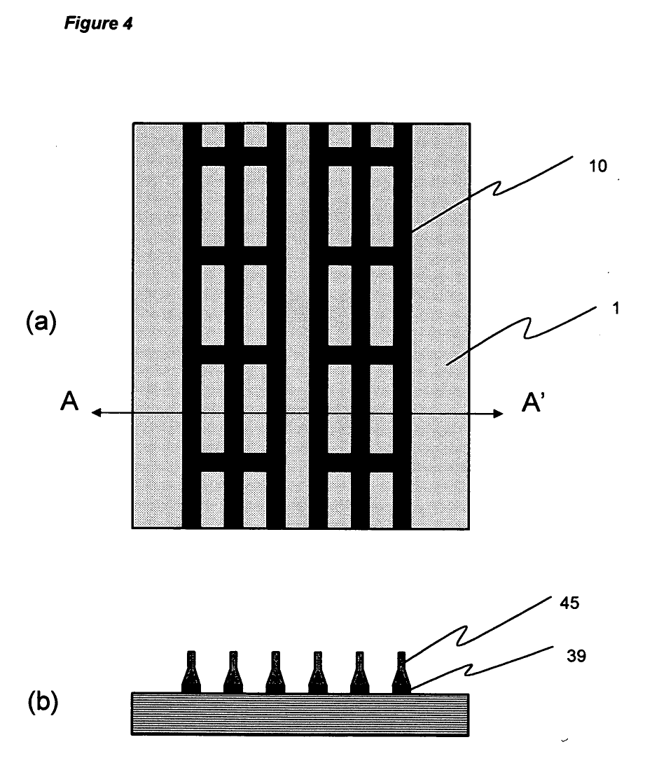

After step 3, the front panel is applied. The part of the irradiated photosensitive paste dilutes faster than that of the non-irradiated paste. Step 4 drawing in FIG. 4 shows a cross sectional view of the electrode structure after the application process. The irradiated and applied positive type black color paste 32 is accurately patterned by aligning it with the dried non-black electric conductive paste.

Step 5 drawing in FIG. 1 shows the cross sectional view of the front panel after the firing process. The condition of the firing process is 550° C. (823 K) kept for 20 minutes. A bus electrode 2 consists of a fired black color ground layer 33 and a fired non-black electric conductive layer 42. After the firing process, the non-black electric conductive layer 41 changes its shape from a half-moon shape to trapezoidal shape shown as the fired non-black electric conductive layer 42. The thickness also reduces to half (7-8 μm) by the firing process. The typical electric resistance of the bus electrode in a 42 inch diagonal color-PDP is in the range from 75 to 83Ω.

### ALTERNATIVE EMBODIMENTS

### 2nd Embodiment

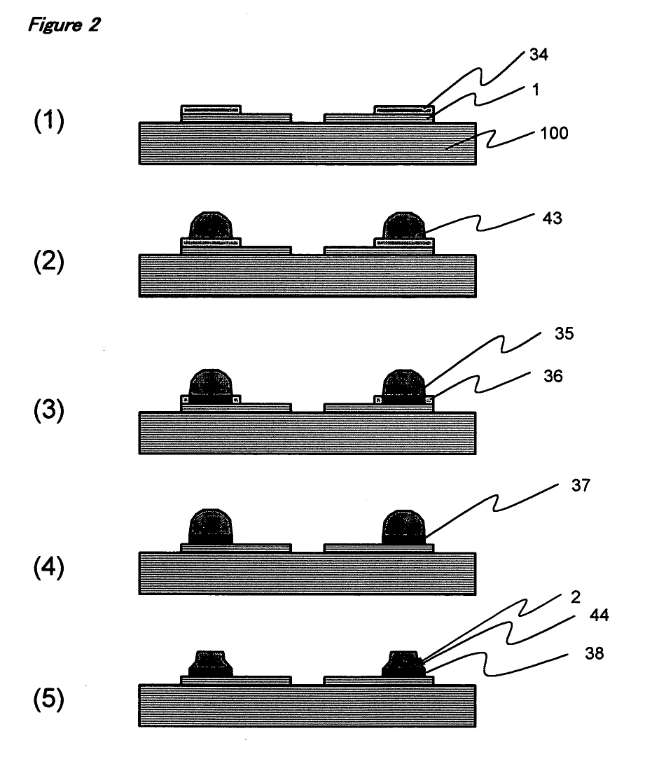

The 2nd embodiment of this invention is explained by using FIG. 2. This 2nd embodiment is similar to the 1st embodiment (the preferred embodiment), except for the different features at step 1 and step 2. At step 1 in FIG. 2, the positive type photosensitive black color paste 31 is printed on the entire surface of the front panel 100 by using a polyester 380 mesh screen mask. At step 1, it is not necessary to align the mask to the sustain scan electrode pattern.

At step 2, a non-black color electric conductive paste is printed by aligning the mask to the sustain scan electrode pattern.

### 3rd Embodiment

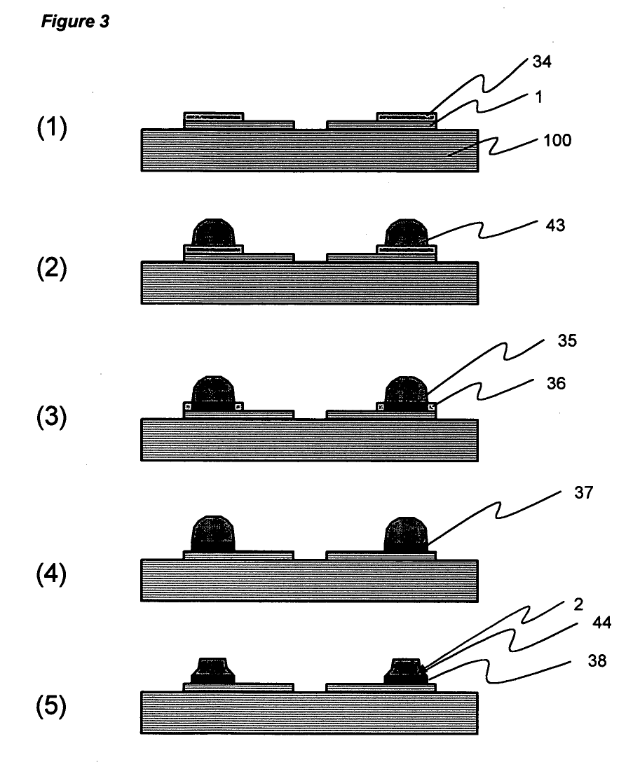

The 3rd embodiment of this invention is explained by using FIG. 3. This 3rd embodiment is similar to the 1st embodiment (the preferred embodiment), except that the 3rd embodiment uses a chemical sensitive paste for the ground black color layer instead of the photosensitive paste that is used as explained in the 1st embodiment. At step 1 in FIG. 3, a sustain scan electrode 1 is firstly formed on the front panel 100, and then a chemically sensitive black color paste is secondly printed on the part of the sustain scan electrode.

At step 2, a non-black electric conductive paste including a stiffening ingredient 43 is selectively printed.

At step 3, the chemically sensitive black color paste reacts with the non-black paste during 20 min. annealing at 100° C. (373 K). The stiffened part of the black color paste is touching the non-black paste part shown as stiffened black paste 35. The other part is not stiffened (labeled as non-stiffened black paste 36).

After step 3, the non-stiffened black paste is removed by an ethanol shower.

Step 4 drawing shows the cross sectional view of the front panel structure after the ethanol shower process. A ground layer covered by the non-black electric conductive layer remains as a pattered black color ground layer 37. The etch position of the ground layer is accurately aligned to the etch position of the electric conductive layer. Step 5 drawing shows the cross sectional view of the front panel structure after the firing process. A bus electrode 2 has a double layer structure comprising a fired non-black electric conductive layer 44 and a fired black color ground layer 38.

### 4th Embodiment

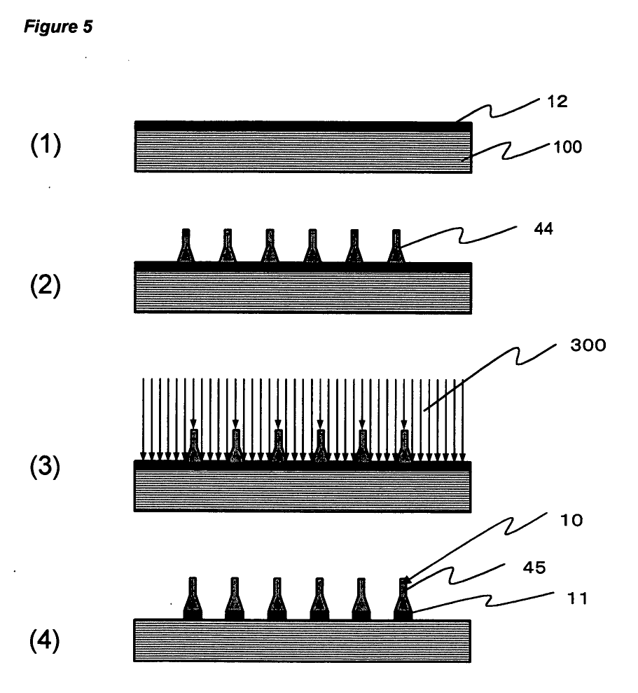

The 4th embodiment of this invention is explained by using FIGS. 4 and 5. FIG. 4 shows the fence electrode 10 structure, which can sustain light emission without a transparent electrode. FIGS. 4 (a) and (b) show a plane view and a cross sectional view at A-A′ position respectively. This fence electrode 10 is comprised of the feature of a double layer comprising a black color ground layer 39 and a non-black electric conductive layer 45. This fine patterned double layer fence electrode can solve trade-off relation problems of increasing black-white contrast and decreasing electric resistance. The electric resistance can be decreased by screen printing the non-black electric conductive layer twice.

FIG. 5 shows the fabrication process flow of the fence electrode shown in FIG. 4(b).

At step 1, a black color paste 12 is printed on a front panel 100.

At step 2, silver paste is selectively printed on the black color paste. The printed silver paste pattern is a grid pattern and the line width and the gap between the lines are 40 μm and 80 μm respectively. Step 2 drawing shows the fence electrode structure after the drying and firing processes. After the firing process, the silver paste has a trapezoidal structure shown as a fired non-black electric conductive layer 44.

Step 3 is a sand blast process. Sands 300 rush into the electric conductive layer comprised of fired silver paste and the black color ground layer. The tolerance of the black color ground layer to the sand blast is tuned weaker than that of the electric conductive layer in order to selectively remove the black color ground layer during the sand blast process.

Step 4 drawing shows the fence electrode structure after the cleaning process. The fence electrode has a double layer structure. The sand blast process removes the plains at the conductive layer's foot to form a precipice shape conductive layer. The fabricating process flow shown in FIG. 5 makes a fine precipice shape conductive layer with a precisely aligned black color ground layer.

### REFERENCES CITED

### Japanese Patent Publications No. 2003-238607-A August, 2003 Hideyuki Ito

### Japanese Patent Publications No. 2003-249172-A September, 2003 Hideki Kojima

Japanese Patent Publications No. H10-283937-A October, 1998 Minoru Miyaji
Japanese Patent Publications No. H10-241574-A September, 1998 Osamu Taneda

### Japanese Patent Publications No. 2003-234073-A August, 2003 Lim Jyon-Lee

### Japanese Patent Publications No. 2003-217460-A July, 2003 Hideki Ashido

### Japanese Patent Publications No. 2003-208852-A July, 2003 Keisuke Sumida

### Japanese Patent Publications No. 2003-151450-A May, 2003 Jyo, Yon Dee

### Japanese Patent Publications No. 2003-131365-A May, 2003 Hibiki Ichikawa

Japanese Patent Publications No. H11-65482-A March, 1999 Takeshi Furukawa
Japanese Patent Publications No. 2003-500796-W January 2003 Robert Gee Marcot

What is claimed is:

1. A PDP, which has a front panel and a back panel, which is set at a fixed distance from this front panel;
the front panel has two or more sustain scan electrodes arranged in parallel on the above-mentioned front panel surface, two or more data electrodes arranged in the direction which crosses over the above-mentioned sustain scan electrodes, and two or more partitions that are arranged between the above-mentioned front panel and the above-mentioned back panel in order to divide the electric discharge cell;
the above-mentioned sustain scan electrode has a transparent electrode and a bus electrode arranged on the above-mentioned transparent electrode;
the above-mentioned bus electrode is formed sequentially from the side that touches the above-mentioned transparent electrode with a double layer composition of a black ground layer and a non-black electric conduction layer;
the above-mentioned bus electrode is formed by firstly exposing light on a black color positive type photosensitive paste by using the above-mentioned non-black electric conduction layer as a pattern formation mask, and secondly the above-mentioned paste is applied to make the above-mentioned black ground layer.

2. A PDP as claimed in claim 1, wherein the above-mentioned black ground layer is formed at first by being deposited on the entire surface, and secondly, by being dried and, thirdly, by being partially stiffened at the part which touches the above-mentioned selectively-deposited non-black electric conduction layer with a chemical reaction, and fourthly, being partially removed from the non-stiffened black ground layer.

3. A PDP as claimed in claim 1, wherein the above-mentioned black ground layer is formed at first by being deposited on the entire surface, and secondly, being dried and, thirdly, being selectively deposited the above-mentioned non-black electric conduction layer, and partially removing the above-mentioned black ground layer that is not covered by the above-mentioned non-black electric conduction layer by physical or chemical etching.

4. A PDP, which has a front panel and a back panel, which is set at a fixed distance from this front panel;
the front panel has a number of two or more sustain scan electrodes arranged in parallel on the above-mentioned front panel surface, two or more data electrodes arranged in the direction which crosses over the above-mentioned sustain scan electrodes, and two or more partitions that are arranged between the above-mentioned front panel and the above-mentioned back panel in order to divide an electric discharge cell;
the above-mentioned sustain scan electrode is formed sequentially from the side that touches the above-mentioned front panel with a double layer composition of a black ground layer and a non-black electric conduction layer;
the above-mentioned sustain scan electrode is formed by firstly exposing light on a black color positive type photosensitive paste by using the above-mentioned non-black electric conduction layer as a pattern formation mask, and secondly the above-mentioned black ground layer is applied to make the above-mentioned black ground layer.

5. A PDP as claimed in claim 4, wherein the above-mentioned black ground layer is formed at first by being deposited on the entire surface, and secondly, being dried and, thirdly, being partially stiffened at the place that is touched by the above-mentioned selectively deposited non-black electric conduction layer with a chemical reaction, and fourthly, being partially removed at the non-stiffened black ground layer.

6. A PDP as claimed in claim 4, wherein the above-mentioned black ground layer is formed at first by being deposited on the entire surface, and secondly, being dried and, thirdly, being selectively covered by the above-mentioned non-black electric conduction layer, and partially removing part of the above-mentioned black ground layer that is not covered by the above-mentioned non-black electric conduction layer by physical or chemical etching.

7. A method for fabricating a plasma display panel, comprising the following steps: A transparent electrode is deposited and patterned on a front panel; a black color positive type photosensitivity paste is deposited on both surfaces of the transparent electrode and the portion of the front panel that is not covered by the transparent electrode; the black color positive type photosensitivity paste is dried; a non-black electric conduction layer is selectively deposited by a screen printing method on the deposited black color positive type photosensitivity paste; the part of the black color positive type photosensitivity paste that is not covered by the non-black electric conduction layer is exposed to light; the exposed black color positive type photosensitivity paste is removed by an application process; the front panel is dried.

8. A method for fabricating a plasma display panel, comprising the following steps: A transparent electrode is deposited and patterned on the front panel; a black color positive type photosensitivity paste is selectively deposited on the transparent electrode; the black color positive type photosensitivity paste is dried; a non-black electric conduction layer is selectively deposited on the deposited black color positive type photosensitivity paste by a screen printing method; the part of the black color positive type photosensitivity paste that is not covered by the non-black electric conduction layer is exposed to light; the exposed black color positive type photosensitive paste is removed by an application process; the front panel is dried.

9. A method for fabricating a plasma display panel, comprising the following steps: A transparent electrode is deposited and patterned on the front panel; a black color paste is deposited on both surfaces of the transparent electrode and the part of the front panel that is not covered by the transparent electrode; the black color paste is dried; a non-black electric conduction layer is selectively deposited by a screen printing method on the deposited black color paste; the black color paste is partially stiffened at the part that is touched by the above-mentioned selectively deposited non-black electric conduction layer with a chemical reaction; a part of the non-stiffened black ground layer is removed.

10. A method for fabricating a plasma display panel, comprising the following steps: A transparent electrode is deposited and patterned on the front panel; a black color paste is selectively deposited on the transparent electrode; the black color paste is dried; a non-black electric conduction layer is selectively deposited by a screen printing method on the deposited black color paste; the black color paste is partially stiffened at the part that is touched by the above-mentioned selectively deposited non-black electric conduction layer with a chemical reaction; a part of the non-stiffened black ground layer is removed.

11. A method for fabricating a plasma display panel, comprising the following steps: A transparent electrode is deposited and patterned on the front panel; a black color paste is deposited on both surfaces of the transparent electrode and the part of the front panel that is not covered by the transparent electrode; the black color paste is dried; a non-black electric conduction layer is selectively deposited by a screen printing method on the deposited black color paste; the part of the deposited black color paste which is not covered by the above-mentioned non-black electric conduction layer is removed by physical or chemical etching.

12. A method for fabricating a plasma display panel, comprising the following steps: A transparent electrode is deposited and patterned on the front panel; a black color paste is selectively deposited on the transparent electrode; the black color paste is dried; a non-black electric conduction layer is selectively deposited by a screen printing method on the deposited black color paste; the part of the deposited black color paste which is not covered by the above-mentioned non-black electric conduction layer is removed by physical or chemical etching.

13. A method for fabricating a plasma display panel, comprising the following steps: A black color positive type photosensitive paste is deposited on the entire surface of the front panel; the black color positive type photosensitive paste is dried; a non-black electric conduction layer is selectively deposited on the deposited black color positive type photosensitive paste by a screen printing method; the part of the black color positive type photosensitive paste that is not covered by the non-black electric conduction layer is exposed to light; the exposed black color positive type photosensitive paste is removed by an application process; the front panel is dried.

14. A method for fabricating a plasma display panel, comprising the following steps: A black color positive type photosensitivity paste is selectively deposited on the front panel; the black color positive type photosensitivity paste is dried; a non-black electric conduction layer is selectively deposited by a screen printing method on the deposited black color positive type photosensitivity paste; the part of the black color positive type photosensitivity paste that is not covered by the non-black electric conduction layer is exposed to light; the exposed black color positive type photosensitivity paste is removed by an application process; the front panel is dried.

15. A method for fabricating a plasma display panel, comprising the following steps: A black color paste is deposited on the entire surface of the front panel; the black color paste is dried; a non-black electric conduction layer is selectively deposited by a screen printing method on the deposited black color paste; a part of the black color paste that is touched by the selectively deposited above-mentioned non-black electric conduction layer is stiffened with a chemical reaction; the non-stiffened black color paste is removed; the front panel is dried.

16. A method for fabricating a plasma display panel, comprising the following steps: A black color paste is selectively deposited on the front panel; the black color paste is dried; a non-black electric conduction layer is selectively deposited by a screen printing method on the deposited black color paste; the part of the black color paste which is touched by the above-mentioned selectively deposited non-black electric conduction layer is stiffened with a chemical reaction; the non-stiffened black color paste is removed; the front panel is dried.

17. A method for fabricating a plasma display panel, comprising the following steps: A black color paste is deposited on the entire surface of the front panel; the black color paste is dried; a non-black electric conduction layer is selectively deposited as a stripe pattern by a screen printing method on the deposited black color paste; a part of the black color paste which is not covered by the above-mentioned non-black electric conduction layer is removed by physical or chemical etching.

18. A method for fabricating a plasma display panel, comprising the following steps: A black color paste is selectively deposited in a stripe pattern on the front panel; the black color paste is dried; a non-black electric conduction layer is selectively deposited in a stripe pattern by a screen printing method on the deposited black color paste; the part of the black color paste which is not covered by the above-mentioned non-black electric conduction layer is removed by physical or chemical etching.
